(19) United States
(12) Patent Application Publication
(10) Pub. No.: US 2006/0009206 A1
(43) Pub. Date: Jan. 12, 2006

(54) Method of adding a sector to an active set

(76) Inventor: Asif D. Gandhi, Iselin, NJ (US)

Correspondence Address: LUCENT TECHNOLOGIES INC.;DOCKET ADMINISTRATOR, 101 CRAWFORDS CORNER ROAD - ROOM 3J-219, HOLMDEL, NJ, 07733, US

(21) Appl. No.: 10/885,376

(22) Filed: Jul. 6, 2004

(51) Int. Cl. H04Q 7/20

(52) U.S. Cl. 455/422.1

(57) ABSTRACT

A wireless communication system (20) includes evaluating the reverse link of a mobile unit (22) to determine which sector (24, 26, 28, 30) will be part of the mobile unit active set. In a disclosed example, each sector in the active set notifies neighboring sectors of the mobile unit (22). The notified sectors monitor the reverse link of the mobile unit (22) and determine whether selected criteria are met indicating when a sector can be added to the mobile unit active set.

### FIELD OF THE INVENTION

This invention generally relates to telecommunication. More particularly, this invention relates to wireless communication systems.

### DESCRIPTION OF THE RELATED ART

Wireless communication systems have taken a variety of forms and have become increasingly popular in recent years. Typical call scenarios include a mobile unit such as a cell phone, for example, communicating with a base station within a sector or cell for transmitting voice, data or both to another mobile unit or a conventional telephone. As a mobile unit travels between sectors, the respective base stations handle communications for the mobile unit. There are times when a mobile unit is moving from one sector into another where a hand off between the base stations occurs.

With some conventional analog techniques, there would be a slight pause or break in communication with the mobile unit during the hand off between base stations. With more recent digital technologies, the so-called soft hand off techniques eliminate that break. With a soft hand off, more than one base station handles communications for a particular mobile unit. For example, as a mobile unit is leaving a first sector and entering a second sector, the base stations for the first and second sectors will simultaneously handle communications for that mobile unit. The second sector will be part of the mobile unit's active set before the first sector drops off. In a CDMA system, each of the base stations with which the mobile unit communicates is considered part of that mobile unit's active set.

Conventional wisdom has been to determine which base stations are part of a mobile unit's active set based upon the forward link (i.e., signal transmissions from the base station to the mobile unit). For example, if the pilot strength or the Ec/Io from a particular sector is greater than a specified threshold, that sector may be added to the mobile unit's active set. On the contrary, if the Ec/Io from a particular sector is less than a specified threshold that sector is dropped from the mobile unit's active set.

Relying upon the forward link as an indicator for what sector should be in a mobile unit's active set has stemmed from practicalities associated with many wireless communication systems. For example, in many situations the forward link is a very good indicator of a mobile station's active set. Utilizing a reverse link as an indicator for when to add a sector to an active set requires overhead channel elements to search for candidate mobile units. Previously there were limited numbers of channel elements in operating systems. Additionally, using reverse link information requires communication between the sector base stations regarding a particular mobile unit and the associated active set. Intersector communications have not always been used to the extent where it becomes an easy extension for utilizing a reverse link when determining an active set.

There are situations where utilizing a reverse link for determining an active set would be beneficial. This invention addresses the need for utilizing a reverse link for determining an active set.

### SUMMARY OF THE INVENTION

An exemplary disclosed embodiment of the invention is a method of communication with a mobile unit that includes determining an active set for the mobile unit based on a reverse link of the mobile unit.

In one example, the method includes determining at least one feature of the reverse link for a sector. The sector is added to the mobile unit active set if the determined feature exceeds a threshold.

One example includes facilitating a call for the mobile unit in a first sector. Notifying at least one neighboring sector of that first sector about the mobile unit allows the neighboring sector to monitor the mobile unit reverse link. If at least one feature of the reverse link for the neighboring sector meets a selected criteria, that neighboring sector is added to the mobile unit active set.

Each time that a sector is added to or dropped from the active set, neighboring sectors can be notified of the same so that they can begin monitoring the corresponding mobile unit or cease monitoring that unit, depending on whether a sector has been added or dropped.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a wireless communication system that includes an embodiment of this invention.

FIG. 2 is a flow chart diagram summarizing one example method.

FIG. 3 is a flow chart diagram summarizing selected portions of the embodiment of FIG. 2.

### DETAILED DESCRIPTION

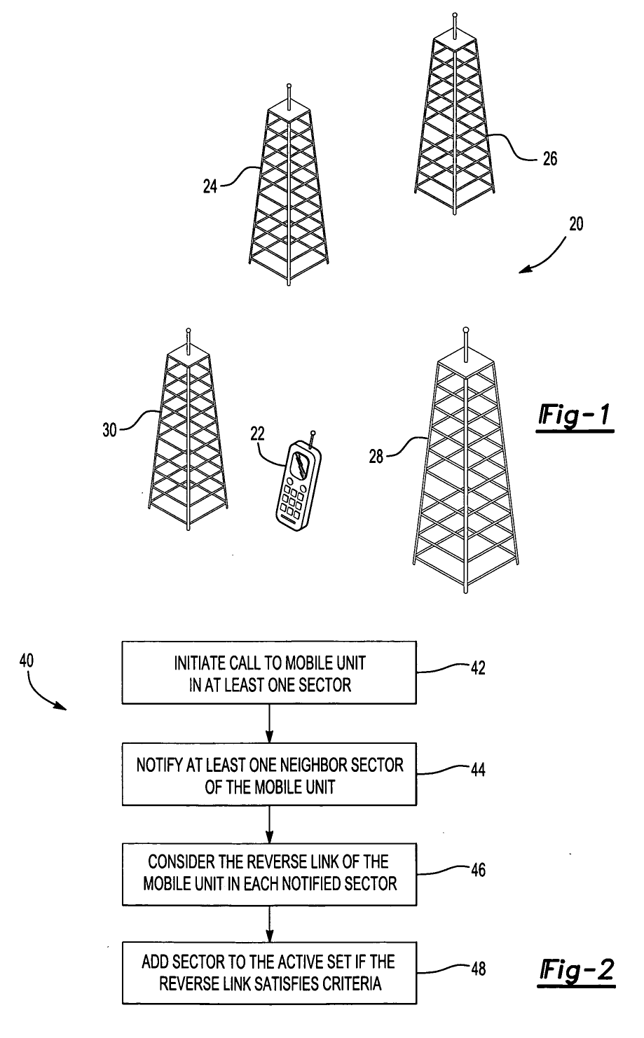

FIG. 1 schematically illustrates a wireless communication system 20 where at least one mobile unit 22 communicates with at least one other device in a known manner. A plurality of base stations 24, 26, 28 and 30 are associated with different cells or sectors, respectively. The mobile unit 22 accomplishes communication with another device in a known manner facilitated through at least one of the base stations. Any of the base stations that currently facilitate communication for the mobile unit 22 is considered part of the mobile unit's active set.

For purposes of discussion, the base station 28 will be considered a primary sector in the mobile unit 22 active set. For example, the mobile unit 22 has a call initiated through the base station 28.

The base station 28 notifies at least one neighboring base station of the mobile unit 22. In this example, the base stations 24, 26 and 30 are considered neighboring base stations to the base station 28. It should be noted that the term “neighboring base station” as used in this description does not necessarily correspond directly to the specific and technical term “neighbor set” used in CDMA standards although the one may include or be a part of the other, depending on the situation.

Each of the base stations neighboring the primary base station 28 determine whether they could become part of mobile unit 22 active set based upon at the reverse link of the mobile unit 22. When selected criteria are met, any qualifying base station can be added to the mobile unit 22 active set. Accordingly, the active set of the mobile unit 22 is determined based upon the reverse link of the mobile unit 22. Of course, a forward link or other indicator may be used in place of or in addition to the reverse link, depending on a particular situation. The discussion of the disclosed example focuses on the reverse link as that is a departure from previously known techniques.

FIG. 2 includes a flow chart diagram 40 summarizing one approach of an example method. In the flow chart 40, a call is initiated for a mobile unit in at least one sector at 42. At 44, at least one neighbor sector is notified of the mobile unit. At 46, the notified sector considers the reverse link of the mobile unit and selected criteria for evaluating the reverse link. At 48, if the evaluated criteria of the reverse link is determined to be satisfactory, that sector is added to the active set of the mobile unit.

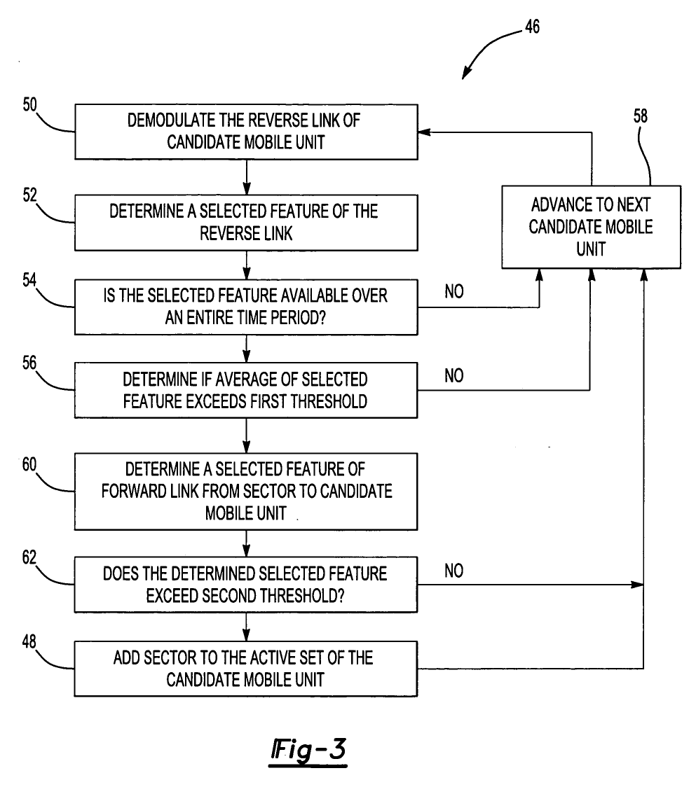

FIG. 3 is a flow chart diagram schematically illustrating one example method of considering the reverse link of the mobile unit in each notified sector. A first step at 50 includes demodulating the reverse link of a candidate mobile unit. The example of FIG. 3 assumes that each notified sector will have a list of more than one candidate mobile unit for evaluation of the corresponding reverse link to determine whether the sector should be added to one or more of the mobile unit active sets. The technique for evaluating the mobile units that are candidates may be performed periodically, sequentially or on an event-driven basis, for example. Those skilled in the art who have the benefit of this description will realize how best to configure a consideration technique for evaluating the reverse links of candidate mobile units.

In one example, a base station of the sector has one or more channel elements assigned to demodulating a reverse link of a candidate mobile unit. In some examples, a plurality of mobile unit reverse links may be demodulated simultaneously. Known techniques can be used for demodulating the reverse link.

A step at 52 includes determining a selected feature of the reverse link. In one example, the ratio of the energy per bit-to-noise ratio (Eb/No) is used as a measure of strength of the reverse link. In another example, the signal-to-interference ratio (C/I) is the selected feature.

According to the example of FIG. 3, a step at 54 includes determining whether the selected feature is available over an entire selected time period. If the feature is not available continuously over the selected time period, the strength of the reverse link is considered weak and below a threshold. Accordingly, that particular candidate mobile unit need not be further considered, at least for the time being. Of course, that same mobile unit can be reevaluated repeatedly as long as that mobile unit is within a list of candidate mobile units for a given sector.

If the selected feature is not available over the entire time period in the example of FIG. 3, a step at 58 includes advancing or incrementing to the next candidate mobile unit on a list and returning to the process of evaluating the reverse link of that next candidate mobile unit.

In the event that the selected feature is available over the entire selected time period, the average of the selected feature is determined at 56. Additionally, the step at 56 includes determining whether the average selected feature satisfies or exceeds a first threshold, which may be considered an add-on-threshold. If the average does not exceed the threshold, then the process proceeds to the step at 58 so that the next candidate mobile unit can be evaluated.

If the average selected feature exceeds the first threshold, a step at 60 includes determining a selected feature of a forward link from the sector to the candidate mobile unit. At 62, a determination is made whether the selected feature exceeds a second threshold. In one example, the steps 60 and 62 include having the notified, neighbor sector which is evaluating the candidate mobile reverse link, contact the primary sector so that the base station of the primary sector instructs the mobile unit to provide a power measurement report from the mobile unit. In one example, a PMRM provides an indication to the notified, neighbor sector how strongly the mobile unit receives signals from that sector. At least one of the primary sector or the notified, neighbor sector checks the Ec/Io (i.e., the pilot strength) with which the candidate mobile unit sees the neighbor sector. In this example, if the Ec/Io exceeds a second threshold, that neighbor sector can be added to the active set of the candidate mobile unit at 48. If the second threshold is not met, then the next mobile unit is considered at 58.

In one example, a new sector is added to a mobile unit active set by communicating with the primary sector base station that the sector is a valid candidate to be added. The base station notifies the mobile unit of the new candidate sector and the mobile unit responds by adding that sector to the active set.

Once a new sector is added to a mobile unit active set, that sector notifies all of its neighboring sectors about the mobile unit and the process repeats for each of those notified sectors.

In this example, whenever a sector is dropped from a mobile unit active set, that sector notifies the neighboring sectors of the drop so that they may cease evaluating or searching for a reverse link from that mobile unit.

In one example, the mobile unit 22 active set includes base stations 26 and 28. The base stations 24 and 30 are neighboring base stations to the base station 26. The base stations 26 and 30 are neighboring base stations to the base station 28. Accordingly, the base stations 24 and 30 monitor the mobile station 22 as a mobile unit in their respective candidate lists.

Assuming that the base station 26 drops from the active set, the mobile station 22 drops from the candidate list of the base station 24 but stays on the candidate list of the base station 30. At the same time, the base station 26, which is a neighboring base station to the base station 28, begins monitoring the mobile station 22 as part of the candidate list for the base station 26.

One example includes prioritizing how the mobile units are scanned when they are part of a candidate list for a particular sector. In this example, the frequency with which the mobile unit reverse links are considered is dependent upon an Eb/No (i.e., energy per bit-to-noise ratio) of each mobile unit. Those mobile units that have a stronger Eb/No may be scanned more often compared to mobile units having a weaker Eb/No. Those skilled in the art who have the benefit of this description will be able to select appropriate thresholds for when to consider a mobile unit'more frequently or less frequently, according to the needs of their particular situation.

In some examples, utilizing the reverse link for determining what sectors are in a mobile unit active set is a supplement to utilizing a forward link for determining the active set. One advantage of utilizing a reverse link-based determination of an active set is that the reverse link signal from the mobile unit is present already and there is no RF power consumption penalty because each base station can be configured to demodulate reverse links as may be considered appropriate for a particular configuration or system.

The preceding description is exemplary rather than limiting in nature. Consequently, the method, system and portions thereof and of the described method and system may be implemented in different locations, such as network elements, the wireless unit, the base station, a base station controller, a mobile switching center and/or a radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Variations and modifications to the disclosed examples may become apparent to those skilled in the art that do not necessarily depart from the essence of this invention. The scope of legal protection given to this invention can only be determined by studying the following claims.

I claim:

1. A method of communication with a mobile unit, comprising:
determining an active set for the mobile unit based on a reverse link of the mobile unit.

2. The method of claim 1, comprising
determining at least one feature of the reverse link for a sector; and
adding the sector to the active set if the determined feature exceeds a threshold.

3. The method of claim 2, comprising determining a strength of the reverse link.

4. The method of claim 2, comprising determining the feature of the reverse link for a plurality of sectors and adding a sector for which the determined feature exceeds the threshold to the active set.

5. The method of claim 1, comprising:
determining that a first sector is in the active set;
notifying at least one neighboring sector to the first sector of the mobile unit; and
determining at least one feature of the reverse link for the neighboring sector.

6. The method of claim 5, comprising:
determining if the feature of the reverse link is available over an entire selected time period;
determining an average of the feature over the selected time period if the feature is available over the selected time period; and
determining if the determined average exceeds the threshold.

7. The method of claim 6, comprising:
determining at least a feature of a forward link from the neighboring sector to the mobile unit if the determined average exceeds the threshold; and
adding the neighboring sector to the active set if the determined forward link feature exceeds a second threshold.

8. The method of claim 5, comprising placing the mobile unit on a candidate list for the neighboring sector.

9. The method of claim 8, comprising periodically evaluating the reverse link of the mobile unit for the neighboring sector.

10. The method of claim 9, comprising determining a frequency of evaluating the reverse link based on the determined feature.

11. The method of claim 1, comprising:
notifying at least one neighbor sector of each sector in the active set of the mobile station;
determining whether the reverse link indicates adding at least one of the notified neighbor sectors to the active set; and
communicating any added sector to the mobile unit.

12. The method of claim 11, comprising notifying at least one neighbor sector of the added sector of the mobile unit responsive to the added sector being included in the active set.

13. The method of claim 1, comprising
dropping a first sector from the active set based on the reverse link; and
notifying at least one corresponding neighbor sector of the first sector dropping out of the active set.

14. The method of claim 13, comprising
determining if any notified neighbor sectors are a neighbor sector to any sector in the active set after dropping the first sector; and
removing the mobile unit from a candidate list of the notified neighbor sector if the notified neighbor sector has no neighbor sectors in the active set.

15. The method of claim 14, comprising continuing to evaluate the mobile unit as part of a candidate list if the notified neighbor sector has at least one other neighbor sector in the active set.

16. The method of claim 1, comprising:
determining a strength of at least one feature of the reverse link; and
determining a frequency of considering the reverse link based upon the determined strength.

17. The method of claim 1, comprising determining whether to add a candidate sector to the active set based on a forward link between the candidate sector and the mobile unit.

18. The method of claim 1, comprising dropping a sector from the active set based on the reverse link and a forward link between the sector and the mobile unit.
